(19) United States
(12) Patent Application Publication
(10) Pub. No.: US 2023/0403309 A1
(43) Pub. Date: Dec. 14, 2023

(54) DYNAMIC CONTROL OF THE DELIVERY OF NOTIFICATIONS CAPABLE OF INVOKING EVENT RECORDINGS

(71) Applicant: MICROSOFT TECHNOLOGY LICENSING, LLC, Redmond, WA (US)

(72) Inventor: Hitesh RATHI, Bellevue, WA (US)

(21) Appl. No.: 17/840,560

(22) Filed: Jun. 14, 2022

(51) Int. Cl. H04L 65/1083; H04L 65/403; H04N 5/76

(52) U.S. Cl. CPC H04L 65/1083; H04L 65/403; H04N 5/76

(57) ABSTRACT

Disclosed systems have dynamic control of notifications capable of invoking actions. A system monitors activity of a meeting to identify participant activity that causes a notification to be sent to an absent user. When participant activity meets one or more criteria, e.g., a person joining a meeting, a critical mass joining a meeting, the system delivers a reminder to one or more absent users. The notification can cause a display of a user-selectable option that allows the absent user to decline the notification and record the meeting. The system can provide customizable policies that allow users to receive notifications, e.g., conditional notifications, when specific scenarios are detected. This way, a person may only receive notifications when contextually relevant conditions are detected. This makes a computer more effective in how information is communicated to users. Users can also invoke a recording without the need to join a meeting and cause interruptions.

### BACKGROUND

There are a number of different types of collaborative systems that allow users to communicate. For example, some systems allow people to collaborate by sharing content using video streams, shared files, chat messages, emails, etc. Some systems also allow people to simultaneously edit documents while also enabling them to communicate using video and audio streams. Users can also establish meetings that enable people to meet at specific times. Existing systems also provide a number of mechanisms that provide reminders to meetings to help improve attendance and coordination between participants.

Although existing collaborative systems provide feature sets that allow people to conduct meetings and provide reminders of those meetings, these systems still have a number of drawbacks. In one example, some existing calendaring systems provide notifications and reminders based on a fixed schedule. A reminder for a meeting can be set to appear at a fixed time before a meeting, e.g., 5 minutes before a meeting, a day before a meeting, etc. These types of notifications are limited in that they cannot adjust to different scenarios. For instance, even if a priority of a meeting changes, existing systems would still provide the same reminder following a fixed schedule. In addition, these types of reminders are limited in the fact that they do not provide additional contextual information regarding a meeting. Further, traditional calendaring systems do not provide reminders that provide any functionality that allows a user to interact with content or people. Thus, if users want to interact with content or people, they may have to actually join the meeting to provide any instruction to others or to interact with shared content. This can cause distractions to others, which can in turn cause many other inefficiencies with respect to the use of computing resources.

### SUMMARY

The techniques disclosed herein provide systems that have dynamic control of notifications capable of invoking event recordings. A system can monitor activity of a meeting to identify participant activity that causes an invitation, also referred to herein as a “notification,” to be sent to an absent user. When participant activity meets one or more criteria, e.g., a person joining a meeting, a critical mass joining a meeting, the system delivers a reminder to one or more absent users. The invitation can cause a display of a first user-selectable option that allows the absent user to accept the invitation join the meeting, and a second user-selectable option that allows the absent user to decline the invitation and record the meeting. In response to receiving an indication that the absent user declined the invitation, the system can record the event and deliver the recording to the absent user. The system can provide customizable policies that allow users to receive invitations, e.g., conditional invitations, when specific scenarios are detected. This way, a person may only receive an invitation when their manager shows up to a meeting, a CEO shows up to a meeting, when certain content is shared, etc. The system can control the delivery of an invitation to mitigate distractions that may be caused by unnecessary, or unwanted invitations. By reducing the number of unwanted invitations, a user will pay more attention to the reminders given that they are more contextually relevant. Thus, making a computer more effective and efficient in how information is communicated to users. Also, by having a reminder that is only sent in response to activity of participants of the meeting, the system can provide a timely reminder that is only sent in response to events that matter to a particular user.

The techniques disclosure in provide a number of technical benefits. For instance, by providing systems that only sends invitations in response to the detection of specific user activity, computers can provide a more effective exchange of information by only sending reminders when they are wanted, and also allowing a user to invoke meeting functionality by responding to the reminder. In configurations where a user can establish a policy and configure criteria that filters the delivery of invitations or meeting notifications, a system can improve its effectiveness in communicating with users. This can help mitigate situations where people get inundated with notifications and start to ignore important signals generated by a computer. This can ultimately help people attend meetings and avoid the need to use other resources to obtain missed information.

The disclosed features also help mitigate occurrences where users that are already in a meeting are unnecessarily interrupted. In addition, these features allow users to control aspects of a meeting, e.g., invoke a recording, without requiring that user to join a meeting, potentially interrupt the meeting, invoke a recording, and the depart the meeting. All of these steps can be skipped while also mitigating the interruptions of receiving automated invitations that may not be sent at optimal times. The techniques disclosed herein can help deliver invitations and reminders at contextually relevant times, or in response to contextually relevant events that are important to a recipient. Mitigation of unnecessary or unwanted reminders and invitations can help avoid situations where recipients start to ignore communication from a system.

These features can also have other benefits in that, since a user does not need to join a meeting to start a recording, others are not distracted. A reduction in distractions to others is important because that helps avoid situations where shared content is missed or overlooked. This can reduce occurrences where users need to re-send information. More effective communication of shared content can also help avoid the need for external systems, such as mobile phones for texting and other messaging platforms. This can help reduce the duplicative use of network, processor, memory, or other computing resources especially when prolonged meetings or additional meetings can be avoided.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 illustrates an example embodiment where a conditional invitation to join a communication session is sent to one or more devices of non-attendees in response to determining that a threshold number of attendees have joined the communication session.

FIG. 2A illustrates a user interface showing general aspects of a communication application.

FIG. 2B illustrates an example of a conditional invitation having a first format that is displayed prior to a start time of an event.

FIG. 2C illustrates an example of a conditional invitation having a second format that is displayed after to a start time of an event.

FIG. 2D illustrates an example a user interface of a communication application showing a private chat session.

FIG. 2E illustrates an example of a notification of a status of a recording that is displayed on user interface of a communication application showing a private chat session.

FIG. 2F illustrates an example of a user response to a notification of a status of a recording that is displayed on user interface of a communication application showing a private chat session.

FIG. 2G illustrates a user interface of a communication application of meeting data that is displayed in response to a user selection of a recording notification.

FIG. 3 illustrates an example embodiment where a conditional invitation to join a communication session is sent to one or more devices of non-attendees in response to determining that a threshold number of attendees have joined the communication session within a threshold time of a start time of a meeting.

FIG. 4 illustrates an example embodiment where a conditional invitation to join a communication session is sent to one or more devices of non-attendees in response to determining that a specific person or a person having a specific title or rank joined the communication session.

FIG. 5 illustrates an example embodiment where a conditional invitation to join a communication session is sent to one or more devices of non-attendees in response to determining that a specific person or a person having a specific title or rank joined the communication session within a threshold time of a start time of a meeting.

FIG. 7 is a flow diagram showing aspects of a routine for implementing aspects of the techniques and technologies presented herein.

FIG. 8 is a computer architecture diagram illustrating an illustrative computer hardware and software architecture for a computing system capable of implementing aspects of the techniques and technologies presented herein.

FIG. 9 is a computer architecture diagram illustrating a computing device architecture for a computing device capable of implementing aspects of the techniques and technologies presented herein.

### DETAILED DESCRIPTION

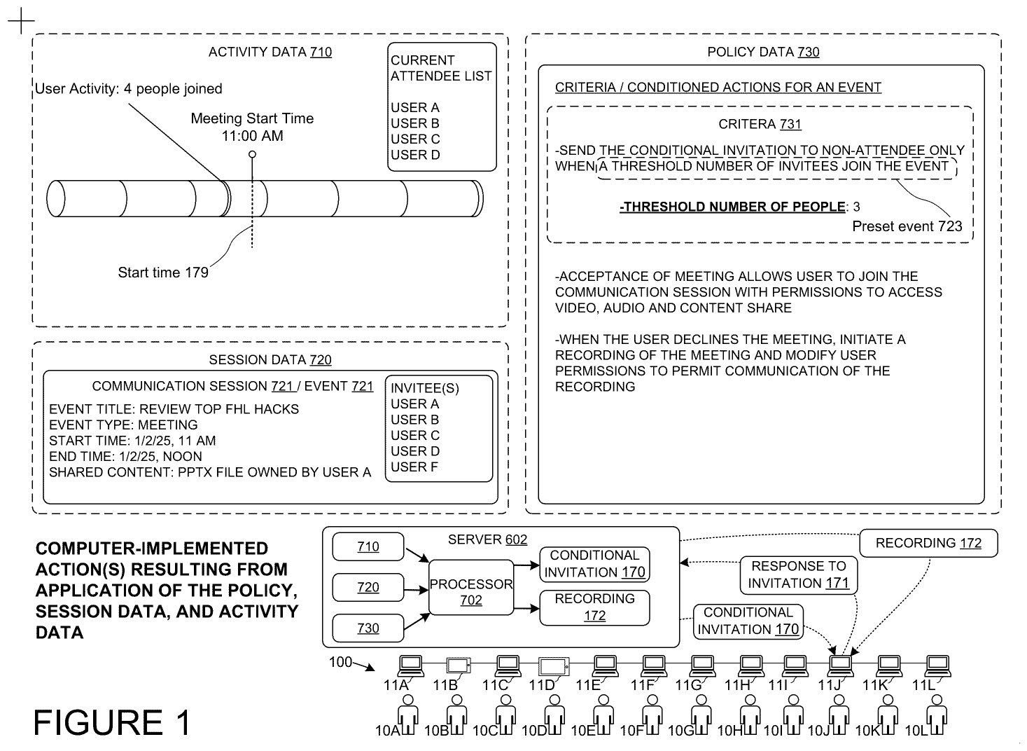

FIG. 1 illustrates an example of a scenario where a system provides dynamic control of invitations capable of invoking event recordings. In this example, a number of people 10 are participating in a communication session, which can involve the communication of messages, shared content, audio, and video streams. The communication session can be managed by a system 100 comprising a number of computers 11 each corresponding to a number of users 10. The techniques disclosed herein can operate on a single device, or operate on a computing platform that utilizes a combination of computers, including the servers described herein.

In this example, the First User 10A is associated with the first computer 11A, the Second User 10B is associated with the second computer 11B, the Third User 10C is associated with the third computer 11C, the Fourth User 10D is associated with the fourth computer 11D, the Fifth User 10E is associated with the fifth computer 11E, the Sixth User 10F is associated with the sixth computer 11F, the Seventh User 10G is associated with the seventh computer 11G, the Eighth User 10H is associated with the eighth computer 11H, the Ninth User 10I is associated with the nineth computer 11I, and the tenth User 10J is associated with the tenth computer 11J. These users can also be respectively referred to as “User A,” User B,” up to User N. These users can also be respectively referred to as “User A,” User B,” “User C,” etc. Each user can be displayed in a user interface as a two-dimensional image or a 3D representation. The 2D image can be a static image or a video stream generated by a camera directed to a user. The users can also communicate using live audio streams. The computers can be in the form of desktop computers, head-mounted display units, tablets, mobile phones, etc.

The system can utilize activity data 710, session data 720, and policy data 730 to determine when an invitation 170 should be sent to a person. For illustrative purposes, the invitation 170 can also be referred to herein as a conditional invitation 170, and the conditional invitation 170 can be sent to a user, such as User J, who has not joined an event. The activity data 710 can include attributes of user activity relating to an event such as a meeting. This can include activity data of a time and date of when a person has joined a meeting, a time and date of when a person has left a meeting, a current attendee list, and a list of people who are absent from the event. The activity data can include titles, rankings or other information pertaining to any of the participants. The activity data can also define activity such as, if and when a person has accepted or declined a meeting, etc. For illustrative purposes, an attendee is a user that has used a client computer to join a communication session, such as a meeting or a broadcast. Joining a communication session includes any type of activity with respect to the session, which can include but is not limited to communication of videos streams, audio streams and/or messages.

The session data 720 can define events 721, where an event can be a meeting. The session data can define a start time, end time, event title, an event type, e.g., meeting, broadcast or panel discussion, Q&A session, etc. The session data can also list the people who have been invited to a meeting, e.g., maintain a list of invitees, and a list of content that is to be shared in the meeting. As described herein, certain types of content that pertains to invitees can also trigger the delivery of a conditional invitation 170.

An event 721 can be a portion of a communication session. A communication session can start when a user joins a system and enables the communication of at least one of video data, audio data, or shared content. Thus, computer users can be engaged with a communication session before or after a meeting so long as they are able to communicate media with others users that are invited to the communication session and/or have joined the communication session. An event or a communication session can be associated with a subject such as a meeting subject. Users can join the communication session before the event and remain connected after the end of the event, e.g., a meeting. This means that users can still communicate messages to a thread of a meeting after a meeting has ended. While a user's computer is connected to the communication session, the user can exchange video data, audio data, and content. Content can include messages, files, etc.

The policy data 730 can define one or more criteria 731 that is used to determine when conditional invitations 170 should be sent. The criteria can also determine which users receive the conditional invitations 170. In this example, the criteria is used to define a policy where non-attendees, e.g., absent users, receive a conditional invitation when a certain number of people join the meeting. In this example, the threshold number of people is 3. Thus, when three people join a meeting, a conditional invitation is sent to people who have been invited to the meeting but not yet joined the event. This policy can be used to create a filter so that invitations are not sent when a critical mass of attendees has not been reached.

The policy data can define a number of preset events 723. A preset event includes any activity related to participants who have joined a communication session. As shown in FIG. 1, a preset event 723 can be a scenario where a threshold number of people have joined the meeting. A preset event can also be a set of preset times. Thus, in applying these examples of preset events, an invitation 170 can be sent 5 minute prior to a meeting start time or an invitation 170 can be sent when 50% of people joined the meeting. A preset event can also include a situation where a predetermined person or a person having a threshold ranking or level joins a communication session. Thus, an invitation 170 can be sent to when a CEO or a person with specific user ID joins a meeting. This can also include a relationship between users. For instance, an invitation 170 can be sent to an absent user, e.g., a person who has not joined a communication session, when that user's manager or team member has joined.

As shown, when the system detects that the activity data 710 defines activity that meets the criteria defined in the policy 730, the system can send the conditional invitation to the absent users, such as User J. The policy can also define functionality of the conditional invitation 170. in this case, the conditional invitation is configured with the ability for the user to accept the invitation or deny the invitation. When the user accepts the invitation 170, the system is configured to change the permissions of the system to allow that person to access shared content and join the meeting. When the user declines the invitation 170, the system is configured to initiate a recording of the meeting and change permissions to allow the recipient of the invitation to access the recording. In this case, the system can receive a response 171 from the invitation recipient, and if the response indicates that the user is declining the invitation, the system can generate a recording 172 of the meeting and deliver that recording to the invitation recipient.

For illustrative purposes, an “absent user,” “absent participant” or a “non-attendee” is a user that has not joined a communication session. Such users are not in communication with other attendees using the communication system. A non-attendee can include any user that has received an original invitation or a user that has not received an original invitation. The conditional invitation 170 can be an invitation that is sent based on the detection of a particular state of activity data described herein. The conditional invitation 170 can be sent after an original invitation has been sent, where an original invitation is sent when an event organizer has setup a meeting and listed invitation recipients as attendees. The original invitation can be sent to one or more invitees when an event organizer, e.g., a communication session organizer, defines the event parameters, e.g., the event title, event start time, etc.

A participant can be either an attendee or a non-attendee. A participant can be a person who was invited to the meeting or has permissions to interact with the functions of a communication session. A communication session can include an event, such as a meeting or broadcast. A communication session can also include other forms of communication that are ongoing beyond an event. For example, the communication session can include a video sharing session, a chat session, an audio sharing session, or a multi-user content editing session. The communication session can be in the form of a meeting or other event with a start time and an end time. Participants can join the communication session before the start time and can stay engaged in the session after the end time.

Invitees are individuals who have received an invitation to join a session or are listed on an invitee list. When a user is described as joining a communication session, a computing device associated with that user is invoked by an input or by an automated trigger to join a session. Although some examples stated herein illustrate that a user has joined a session or it has exited a session, the present disclosure also means that a computing device can join a session or exit a session with or without a user input. Thus, computing devices can perform all of the techniques disclosed herein without human interaction.

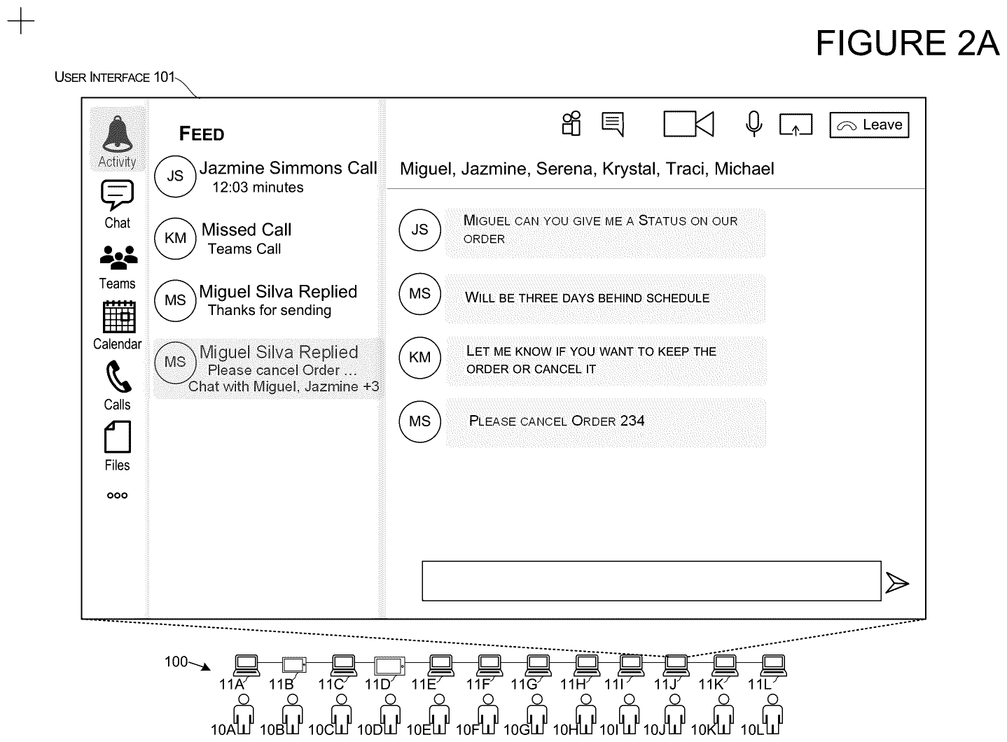

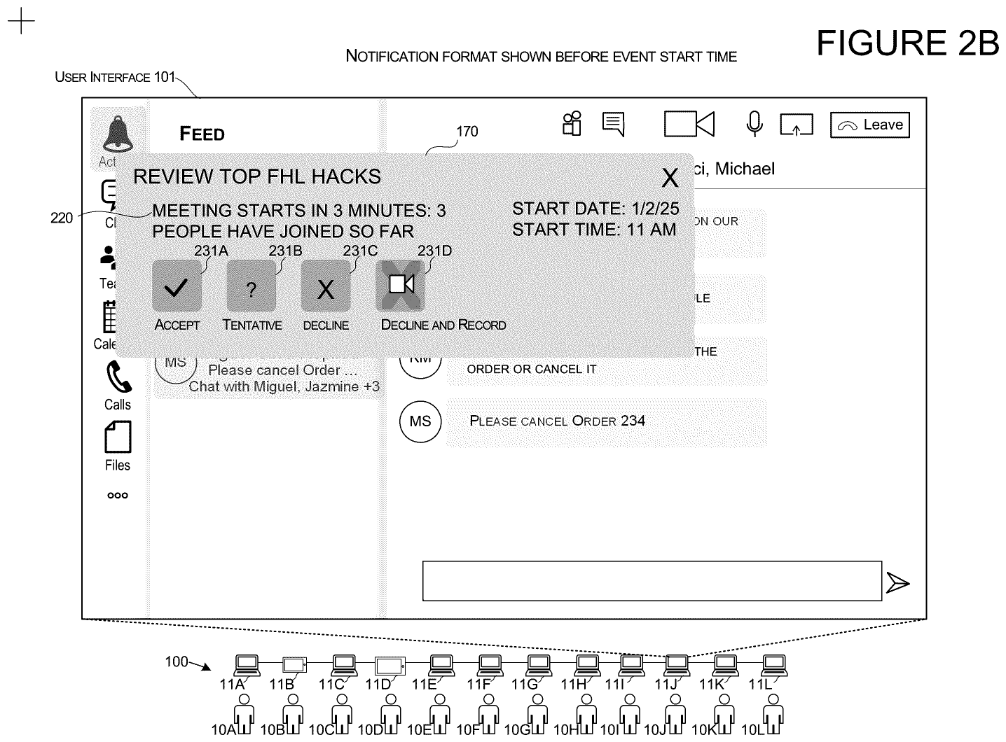

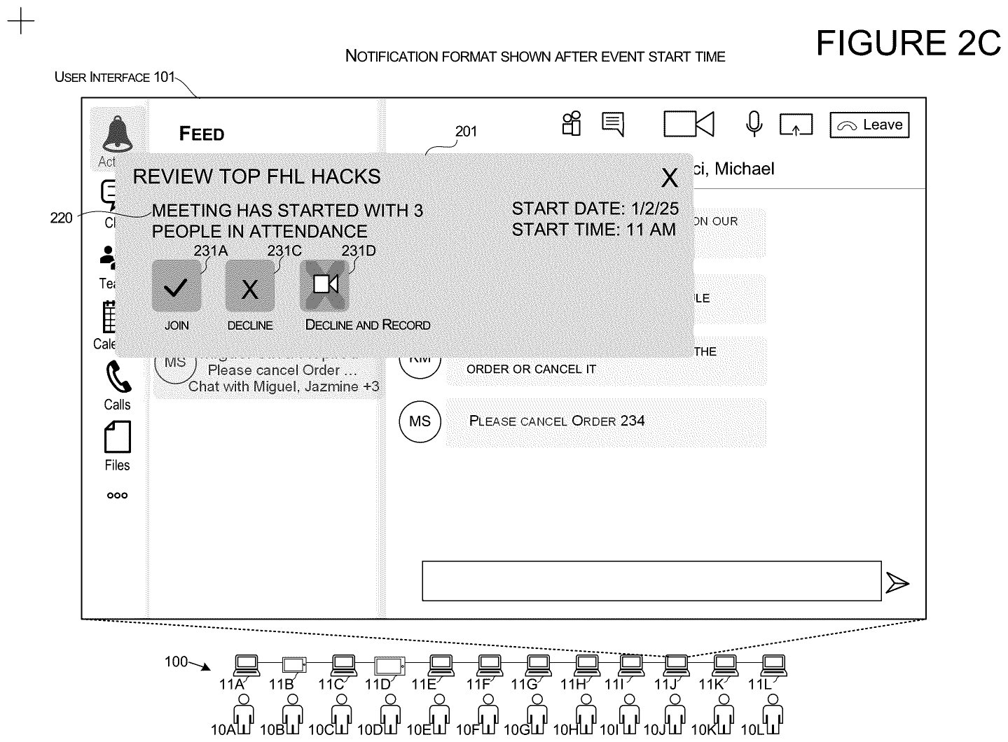

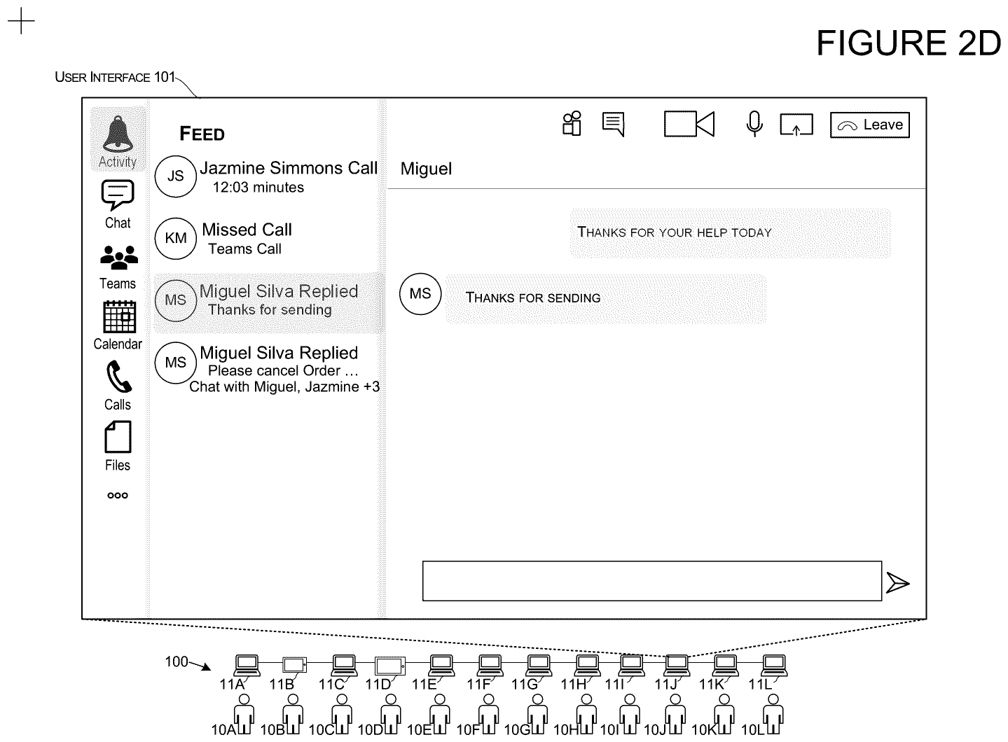

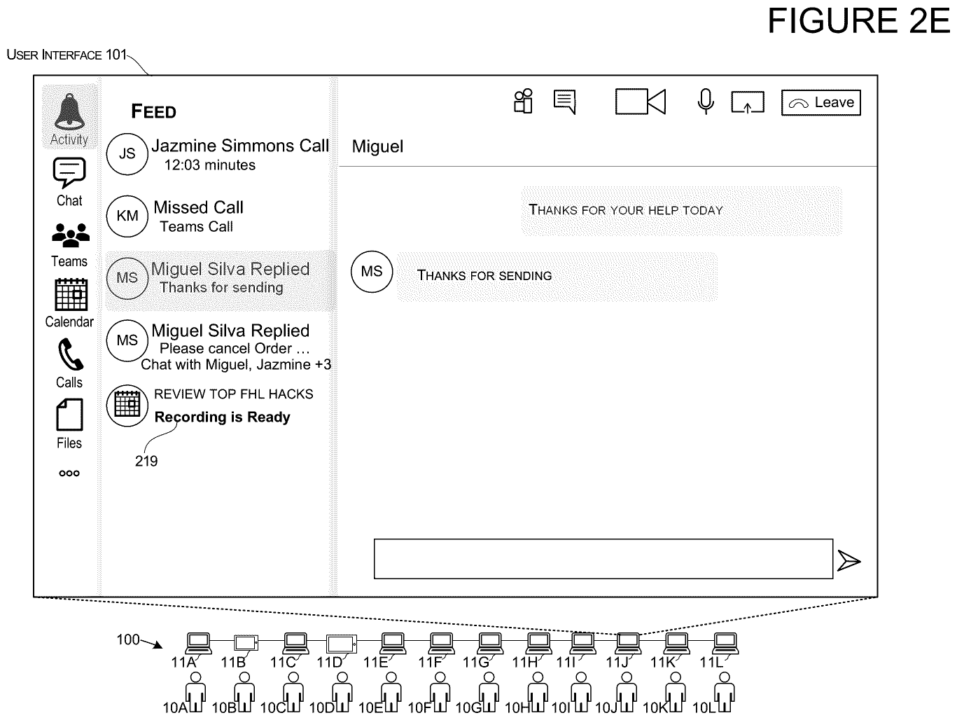

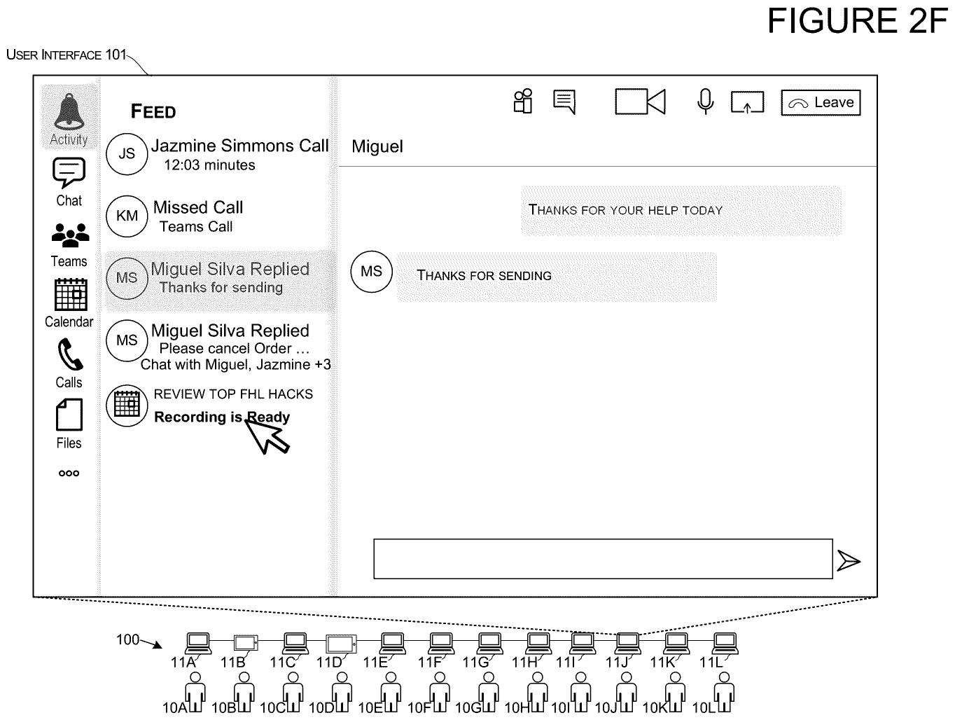

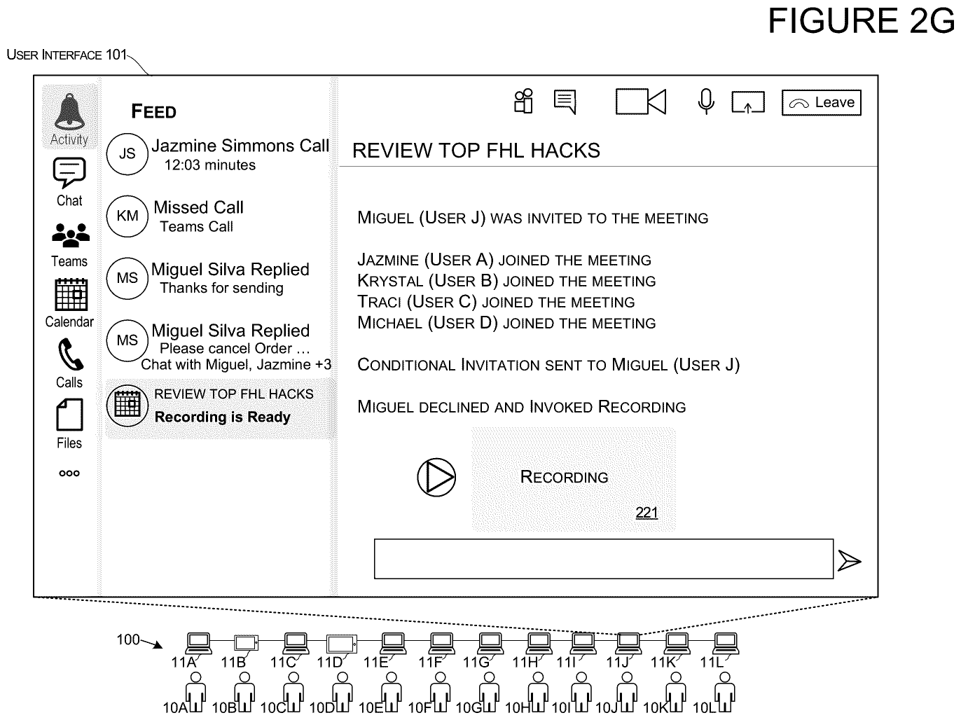

Referring now to FIG. 2A-2G, examples of how a conditional invitation and they recording is delivered to a user. FIG. 2A illustrates a user interface showing general aspects of a communication application. In this example, User J, is viewing a particular chat session with several users. In continuing the example described above with respect to FIG. 1, when the user activity meets the one or more criteria of the policy data, the system can send a conditional invitation 170, which is also referred to herein as a conditional notification 170. FIG. 2B and FIG. 2C illustrate examples of conditional notifications for an event displayed on a user interface of a communication application. As shown, the conditional invitation 170 can be displayed while the user is in any operational state of a communication application, e.g., during a time the user is looking at a chat session. In some configurations, the system can display a first format of the conditional notification 170 when the conditional notification 170 is displayed prior to a start time of a meeting. This first format is shown in FIG. 2B. In some configurations, the system can display a second format of the conditional notification 170 when the conditional notification 170 is displayed after to a start time of a meeting. This second format is shown in FIG. 2C.

The first format of the conditional notification 170 can provide a notice 220 that a meeting is about to start, and also indicate some activity information related to that person's policy, e.g., if User J has established a preset condition in a policy to provide a notice when 3 people join, the notice 220 will indicate the activity relative to that policy, e.g., that 3 people have joined so far. The second format of the conditional invitation 170 can provide a notice 220 stating the meeting has started and also give a status with respect to the attendee activity relative to a preset condition, e.g., provide a number of people that have joined, provide name of a person that has joined, e.g., a person of interest to the viewer, such as the viewer's manager, a CEO, etc.

As shown in FIG. 2B, the first format of the conditional invitation 170 can include a first selectable element 231A that allows a user to accept the invitation to the event, e.g., a meeting, a second selectable element 231B that allows the user to respond indicating that their attendance is tentative, a third selectable element 231C that allows the user to respond and decline the event, and a fourth selectable element 231D that allows the user to respond by declining the meeting and initiate a recording of the meeting. When the user accepts the invitation to the event or indicates a tentative attendance, the system sends one or more notifications to other invitees indicating the corresponding intent. When the user declines the event prior to the start of the meeting, the system can remove that calendar event from the user's calendar. When the user declines the event and requests a recording prior to the start of the meeting, the system can keep the meeting on the person's calendar and initiate a recording at the start time or at a time when the activity data defines user activity that meets one or more criteria defined in the policy. Although these examples illustrate a notification in the form of a pop-up menu that is displayed in response to activity data meeting one or more criteria of a policy, e.g., a preset event, the conditional invitation 170 or conditional notification 170 can be delivered to any absent user using any suitable mechanism such as an e-mail, an instant message, text messages, etc. For illustrative purposes, the terms conditional invitation 170 and conditional notification 170 can be used interchangeably.

As shown in FIG. 2C, in the second format of the conditional invitation 170 can include a first selectable element 231A that allows a user to join the event, another selectable element 231C that allows the user to respond and decline the event, and yet another selectable element 231D that allows the user to respond by declining the meeting and initiate a recording of the meeting. The conditional invitation 170 can also provide a notice 220 indicating a status of the event, e.g., show the activity data and a description of how the activity data applies to the policy. In this case, the status includes a description that the criteria of the invitation has been met, e.g., the text indicates that a critical mass is in attendance. When the user accepts the invitation to join the event, the system can transition the UI to show aspects of the meeting, which can include shared video, audio and content. When the user declines the event, the system can remove that calendar event from the user's calendar. When the user declines the event and requests a recording prior to the start of the meeting, the system keep the meeting on the person's calendar and initiate a recording. The recording can be retroactive to the actual start time of the meeting or start the time of the user selection of the third element 231D.

In continuing the example, FIG. 2C illustrates an example of a user response to the conditional invitation. Here the user has selected the selectable element 231D that allows the user to respond by declining the meeting and cause a recording of the meeting. This can be done in either the first format or the second format of the conditional invitation 170.

FIGS. 2D-2F show aspects of how the recording can be delivered. In the example, shown in FIG. 2D, a user, such as User J, can be in any session of the application. This example shows that the user is in a user interface of a communication application showing a private chat session. When the recording is ready for delivery, as shown in FIG. 2E, the system can provide a notification 219 indicating that the recording is ready. Then, as shown in FIG. 2F, the user can select that notification 219 to view the recording. In response to the user selection, as shown in FIG. 2G, the user interface can transition to show aspects of the meeting, including a region 221 that shows a playback of the recording. The recording can be audio and/or video media. Although this example illustrates a user interface of a communication application that can deliver a recording. The techniques disclosed trend can involve any type of delivery mechanism that allows a user to access a recording stored on the system. This includes emailing a link, emailing a media file, etc.

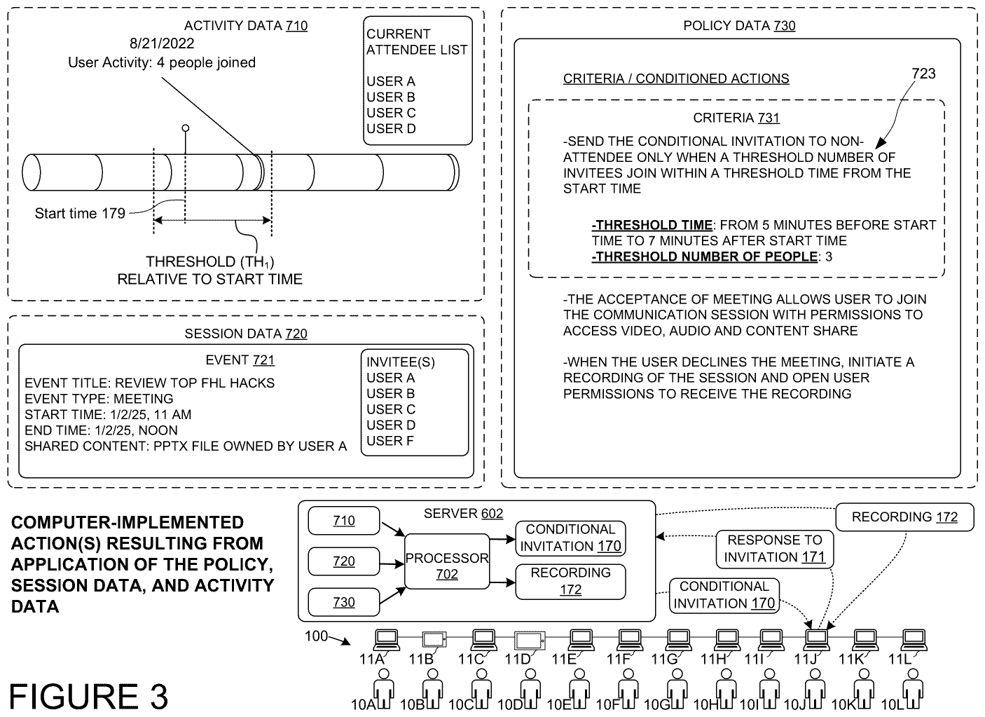

FIG. 3 illustrates another example of a policy that can be used to determine when a conditional invitation can be delivered to one or more users. In this example, the policy can define criteria that enables the system to only deliver a conditional invitation 170 to absent users when the system determines that a threshold number of people have joined a meeting within a threshold time relative to the start time of an event. Thus, if the threshold number of users join too late or too early, the system will not deliver the conditional invitation 170. This policy can be combined with any other policy defined herein. For example, the system may also require content to be shared in addition to this set of criteria in order for a conditional invitation 170 to be sent.

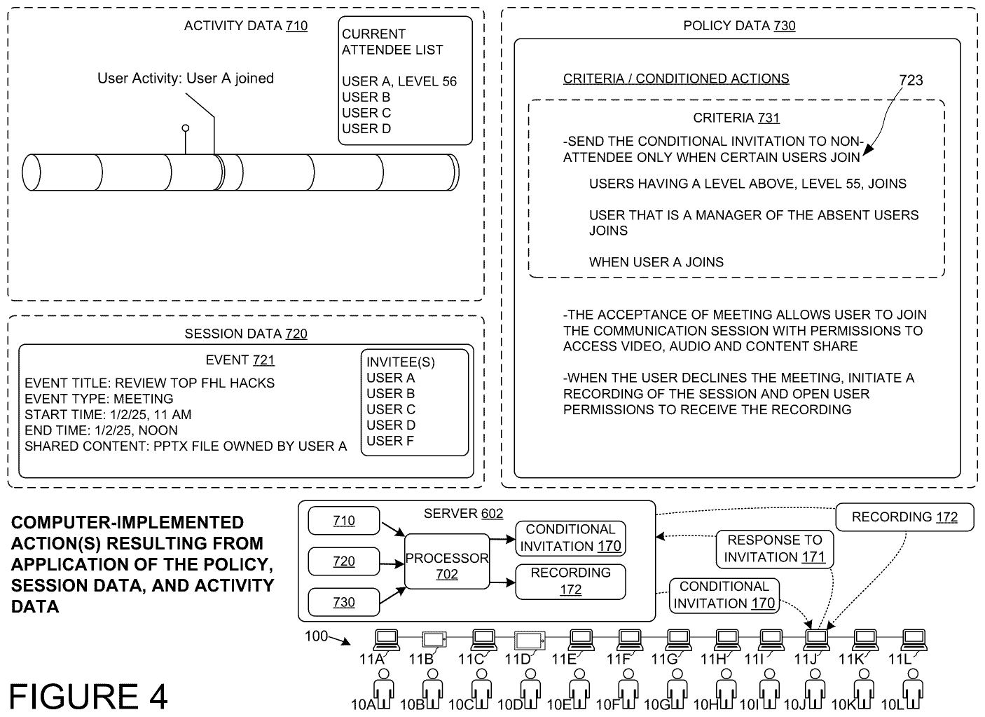

FIG. 4 illustrates another example of a policy that can be used to determine when a conditional invitation can be delivered to one or more users. In this example, the policy can define criteria that enables the system to only deliver a conditional invitation 170 when the system determines that certain users join the meeting. In this example, the conditional invitation 170 is sent only when users above a certain level in an organization join, or when a user who is a manager of an absent user joins, or when a specific user, such as User A, joins. This policy can be combined with any other criteria defined herein. In this example, the system may keep a list of potential attendees for a particular person. When a person on that list actually joins a meeting, the system can send that particular person a conditional invitation 170. This can enable a system to notify a user of a preset event, a key event important to a user, that a person having a role or title has joined, e.g., a keynote speaker, an announced visit by a CEO, that their favorite band showed up to an event, etc.

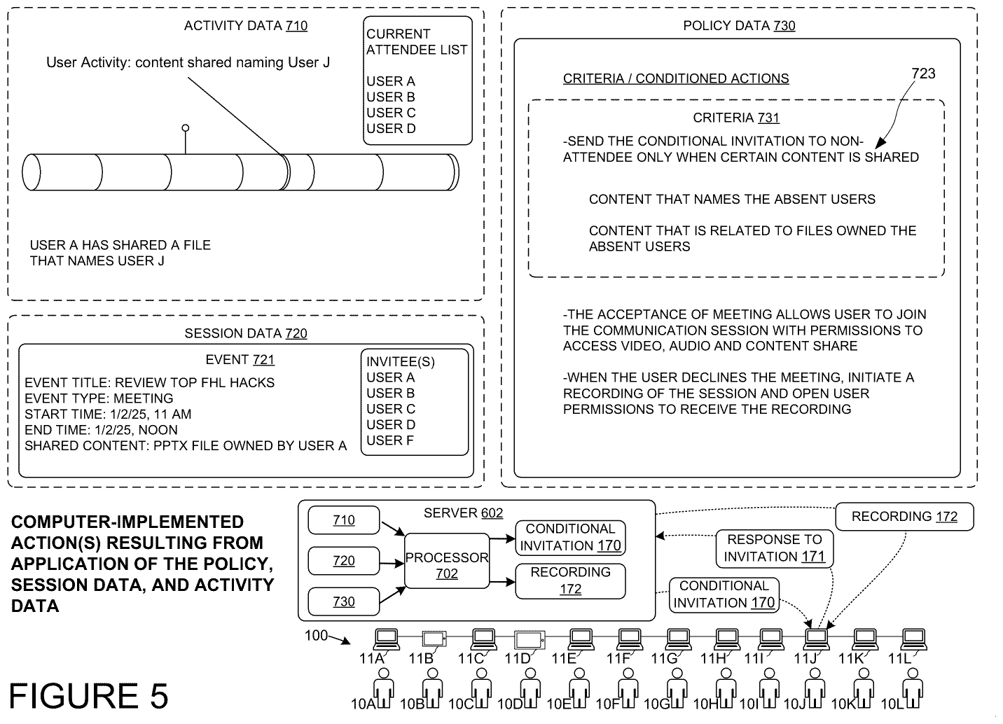

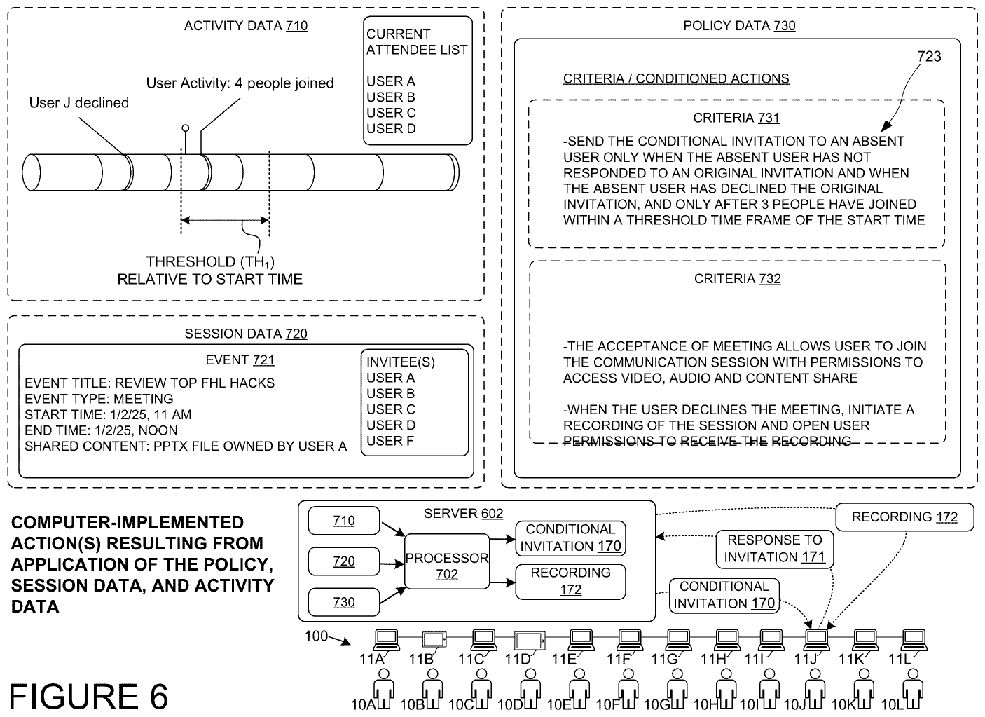

FIG. 5 illustrates another example of a policy that can be used to determine when a conditional invitation can be delivered to one or more users. In this example, the policy can define criteria that enables the system to only deliver a conditional invitation 170 when the system determines that shared content meeting certain rules has been added to the meeting. Specifically, this example shows that an invitation 170 is sent when shared content names an absent user, such as User J. In addition, the invitation 170 is sent when shared content is related to files owned by an absent user, such as User J. This example is provided for illustrative purposes and is not to be construed as limiting. It can be appreciated that any particular set of rules with respect to shared content can apply. For instance, an invitation may be delivered to a user when shared content is related to something that User J has worked on in the past. The relationship can be based on a threshold level of relevancy that uses one or more factors, such as subject matter analysis scores, similarity in keywords, etc. This policy can be combined with any other policy defined herein.

FIG. 6 illustrates another example of a policy that can be used to determine when a conditional invitation can be delivered to one or more users. In this example, the policy can define criteria that enables the system to deliver a conditional invitation 170 to an absent user when the absent user has not responded to an original invitation or when the absent user has declined the original invitation, and after a threshold number of people, e.g., 3, have joined the meeting. For instance, an invitation is sent to User J, if User J is initially invited to a meeting, and the system never receives a response from that user or receives a response that indicates they are declining the invitation, the system can then monitor the activity data to determine when a threshold number of users have joined the meeting. This example is provided for illustrative purposes and is not to be construed as limiting. It can be appreciated that any particular set of rules with respect to a response to an initial invitation can be used to determine when or if an invitation is sent to an absent user. This policy can be combined with any other policy defined herein.

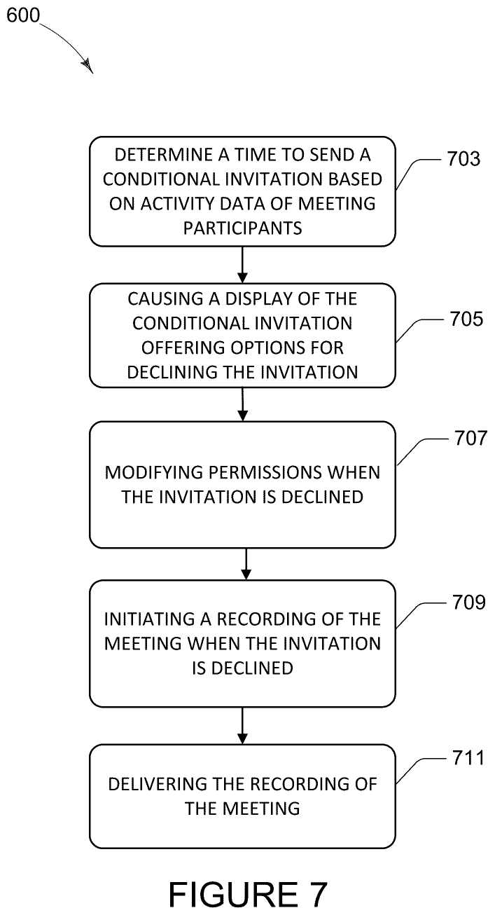

FIG. 7 is a diagram illustrating aspects of a routine 600 for controlling the delivery of invitations capable of invoking actions, such as initiating a recording of a meeting. The techniques disclosed herein provide systems that have dynamic control of event invitations capable of invoking event recordings and other event functionality, such as a content share or an input to a vote. The system also enables a person to control event functionality without requiring the user to join the communication session.

It should be understood by those of ordinary skill in the art that the operations of the methods disclosed herein are not necessarily presented in any particular order and that performance of some or all of the operations in an alternative order is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can start or end at any time and need not be performed in their entirety. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Although the example routine described below is operating on a system, e.g., one or more computing devices, it can be appreciated that this routine can be performed on any computing system which may include any number of computers working in concert to perform the operations disclosed herein.

Thus, it should be appreciated that the logical operations described herein are implemented as a sequence of computer implemented acts or program modules running on a computing system such as those described herein and/or as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof.

Additionally, the operations illustrated in FIG. 7 and the other FIGURES can be implemented in association with the example user interfaces and systems described herein. For instance, the various devices and/or modules described herein can generate, transmit, receive, and/or display data associated with content of a communication session e.g., live content, broadcasted event, recorded content, etc. and/or a presentation UI that includes renderings of one or more participants of remote computing devices, avatars, channels, chat sessions, video streams, images, virtual objects, and/or applications associated with a communication session.

The routine 600 includes an operation 703 where the system monitors activity data of participants a communication session to determine a time to send a conditional invitation. For illustrative purposes, a conditional invitation 170 can also be referred to herein as an invitation or a secondary invitation. The activity data can include any information that identifies or describes the activity of a person with respect to a meeting. This includes information related to their rank or position or role, information indicating whether they have joined a meeting or have left a meeting. Information regarding content that is shared can also be monitored.

In some embodiments, the conditional invitation 170 or conditional notification 170 can be sent to one or more absent users, such as User J, when another invitee of the event forwards an invitation to another person or adds another person to the event. In some configurations, the conditional invitation 170 or conditional notification 170 can be sent to one or more absent users when another invitee of the event forwards the invitation to a predetermined person, such as an absent user's manager, a CEO, or another person of interest to the absent user. For instance, if an attendee forwards an invitation of the meeting to a keynote speaker or a key person of interest for a particular user, based on a policy that is customized by the particular user, the system can send a conditional invitation to that particular user. This way, a conditional invitation 170 or conditional notification 170 can be sent to an absent user in response to a change in the invitee list, which for some people can change a priority of a meeting.

At operation 705, the system can deliver and/or cause the display of a conditional invitation offering options for declining the invitation or accepting the invitation. This can be done in response to the activity data meeting one or more criteria defined in a policy. The invitation can include many other options for allowing a person to decline the invitation without recording a meeting or to decline the invitation and initiating a recording a meeting.

At operation 707, the system can modify permissions. When the user accepts the invitation 170, the system is configured to change the permissions of the system to allow that person to access shared content and join the meeting. When the user declines the invitation 170, the system is configured to initiate a recording of the meeting and change permissions to allow the recipient of the invitation to access the recording. In this case, the system can receive a response 171 from the invitation recipient, and if the response indicates that the user is declining the invitation, the system can generate a recording 172 of the meeting and deliver that recording to the invitation recipient. The invitation can be configured to provide other functionality other than a recording feature. For example, an invitation can include an option for a user to decline the invitation and share content, such as a file. In another example, an invitation can include an option for a user to decline the invitation and allow a user to provide a vote or an answer to a question. This way a person, does not have to join a meeting, cause the generation of a notification that they have arrived, and then cause further disruption by departing the meeting quickly, only to share a file or cast a vote or provide an answer to a question.

At operation 709, the system can initiate a recording of a meeting or initiate any of the other functionality described herein. The recording can include audio and video data that is shared in the meeting. User conversations as well as content that is displayed on a shared screen. The recording can be stored in the system for delivery through any suitable mechanism such as e-mail, a display within a user interface, etc.

At operation 711, the system can deliver the recording to an absent user, such as User J. The delivery mechanism can be through any system that can provide a notification. One example is shown in FIG. 2G, where a user interface can provide notifications that a recording is available and also provide viewing regions for displaying a rendering of the recording.

In general, the routine 700 includes condition(s) for sending the invitation based on activity with respect to the people who are in attendance of the meeting, critical mass in attendance, a key person such as a CEO has arrived, etc. The just-in-time invitation (“conditional invitation”) is only sent when certain conditions are met, and a decline of the invitation initiates a recording. The routine can include a method for controlling delivery of a conditional invitation (170) for a communication session, the method for execution on a system (100), the method comprising operations for monitoring activity data (710) pertaining to a plurality of individuals (10A-10L) of the communication session to determine that the activity data (710) defines activity of one or more attendees (10A-10D) of the plurality of individuals (10A-10L) meets one or more criteria (731) with respect to an event (721), wherein the activity data (710) defining the activity of one or more attendees (10A-10D) is monitored to determine a time that the conditional invitation (170) is communicated to a computing device (11J) associated with an absent user (10J); in response to determining that the activity data (710) defines activity of the one or more attendees (10A-10D) that meets the one or more criteria (731) with respect to the event (721), causing a display of the conditional invitation (170) to the event (721) on the computing device (11J) associated with the absent user (10J), wherein the conditional invitation (170) causes a display of the UI shown in FIG. 2B, where a UI shows the invitation with at least two options: accept and decline with record, this includes a first selectable option (231A) for causing the computing device (11J) associated with the absent user (10J) to accept the conditional invitation (170) and join the event (721), and a second selectable option (231D) for causing the computing device (11J) associated with the absent user (10J) to generate an invitation response (171) to decline the conditional invitation (170) and cause a generation of a recording (172) of the event (721); and in response to receiving the invitation response (171) to decline the conditional invitation (170) and cause the generation of the recording (172) of the event (721), causing the generation of the recording (172) of the event (721); and communicating the recording (172) of the event (721) to the computing device (11J) associated with the absent user (10J).

Any of the operations in the routine can include embodiments where the invitation is sent when a quorum is present, e.g., a critical mass is in attendance. For instance, the user activity of one or more attendees meets one or more criteria with respect to the event when a number of the one or more attendees that have joined the event exceeds a threshold number, wherein the conditional invitation is communicated to the computing device associated with the absent user for display in response to determining that the number of the one or more attendees that have joined the event exceeds the threshold number.

Any of the operations in the routine can include embodiments where the invitation is sent when key individuals have joined, e.g., manager, CEO, etc. For instance, the user activity of the one or more attendees meets one or more criteria with respect to the event when the one or more attendees have identities listed in a participant list, wherein the identities listed in the participant list are controlled by users with administrative permissions or has a moderator role in the event, wherein the conditional invitation is communicated to the computing device of the invitee for display in response to determining that the one or more attendees have identities listed in the participant list.

Any of the operations in the routine can include embodiments where the invitation is sent when the invitee did not respond to an original invitation or replied as tentative, the invitation is not sent if the declined initially. For instance, the user activity of the one or more attendees meets one or more criteria with respect to the event when it is determined that a reply to an initial invitation addressed to the absent user indicated a tentative attendance or the reply to the initial invitation was not received by the system, wherein the conditional invitation is communicated to the computing device associated with the absent user for display in response to determining that the reply to the initial invitation addressed to the absent user indicated the tentative attendance or the reply to the initial invitation was not received by the system, wherein the conditional invitation is restricted from communication to the computing device associated with the absent user if the reply to the initial invitation indicated a rejection to the event.

Any of the operations in the routine can include embodiments where the invitation is sent when the invitee is listed as out of office. For instance, the user activity of the one or more attendees meets one or more criteria with respect to the event when the absent user has an associated identity on a status list, wherein the conditional invitation is communicated to the computing device associated with the absent user for display in response to determining that the absent user has the associated identity on the status list and that the identity is marked as out of office.

Any of the operations in the routine can include embodiments where the invitation is sent when individuals having certain titles are in attendance, e.g., management shows up to the meeting. For instance, the user activity of the one or more attendees meets one or more criteria with respect to the event when the one or more attendees have identities associated with a predetermined title, wherein the conditional invitation is communicated to the computing device associated with the absent user for display in response to determining that the one or more attendees have identities associated with the predetermined title.

Any of the operations in the routine can include embodiments where the invitation is only sent when individuals having certain roles show up, e.g., the presenter, a panel member, etc. For instance, the user activity of the one or more attendees meets one or more criteria with respect to the event when the one or more attendees have identities associated with a predetermined meeting role, wherein the conditional invitation is communicated to the computing device associated with the absent user for display in response to determining that the one or more attendees have identities associated with the meeting role.

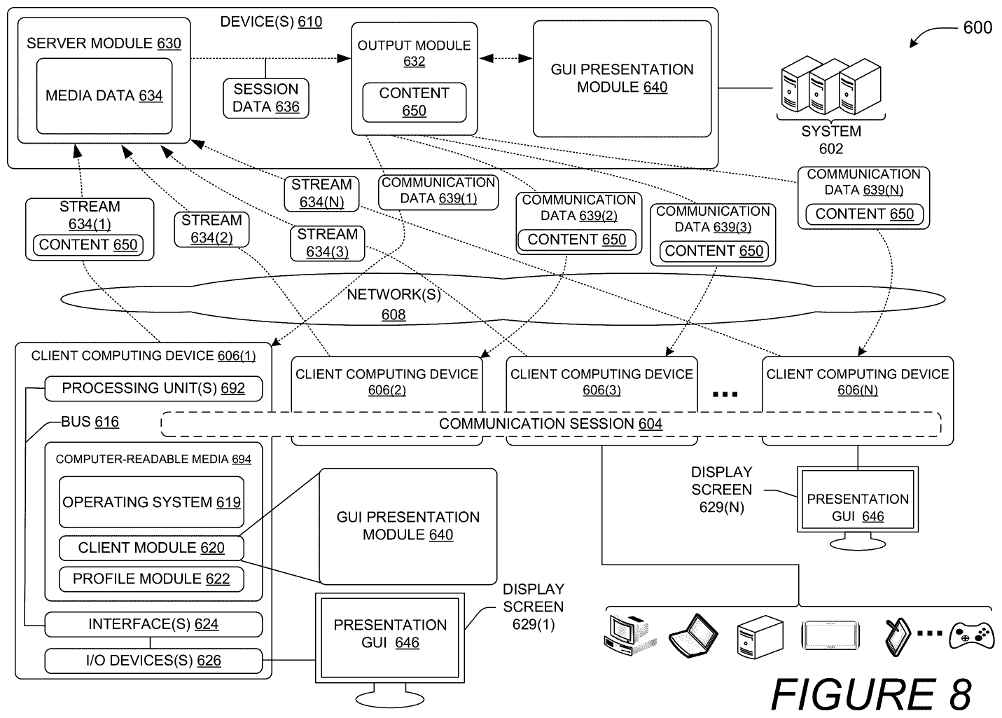

FIG. 8 is a diagram illustrating an example environment 600 in which a system 602 can implement the techniques disclosed herein. It should be appreciated that the above-described subject matter may be implemented as a computer-controlled apparatus, a computer process, a computing system, or as an article of manufacture such as a computer-readable storage medium. The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations.

Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as field-programmable gate arrays (“FPGAs”), digital signal processors (“DSPs”), or other types of accelerators.

All of the methods and processes described above may be embodied in, and fully automated via, software code modules executed by one or more general purpose computers or processors. The code modules may be stored in any type of computer-readable storage medium or other computer storage device, such as those described below. Some or all of the methods may alternatively be embodied in specialized computer hardware, such as that described below.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art.

In some implementations, a system 602 may function to collect, analyze, and share data that is displayed to users of a communication session 604. As illustrated, the communication session 603 may be implemented between a number of client computing devices 606(1) through 606(N) (where N is a number having a value of two or greater) that are associated with or are part of the system 602. The client computing devices 606(1) through 606(N) enable users, also referred to as individuals, to participate in the communication session 603.

In this example, the communication session 603 is hosted, over one or more network(s) 608, by the system 602. That is, the system 602 can provide a service that enables users of the client computing devices 606(1) through 606(N) to participate in the communication session 603 (e.g., via a live viewing and/or a recorded viewing). Consequently, a “participant” to the communication session 603 can comprise a user and/or a client computing device (e.g., multiple users may be in a room participating in a communication session via the use of a single client computing device), each of which can communicate with other participants. As an alternative, the communication session 603 can be hosted by one of the client computing devices 606(1) through 606(N) utilizing peer-to-peer technologies. The system 602 can also host chat conversations and other team collaboration functionality (e.g., as part of an application suite).

In some implementations, such chat conversations and other team collaboration functionality are considered external communication sessions distinct from the communication session 603. A computing system 602 that collects participant data in the communication session 603 may be able to link to such external communication sessions. Therefore, the system may receive information, such as date, time, session particulars, and the like, that enables connectivity to such external communication sessions. In one example, a chat conversation can be conducted in accordance with the communication session 603. Additionally, the system 602 may host the communication session 603, which includes at least a plurality of participants co-located at a meeting location, such as a meeting room or auditorium, or located in disparate locations.

In examples described herein, client computing devices 606(1) through 606(N) participating in the communication session 603 are configured to receive and render for display, on a user interface of a display screen, communication data. The communication data can comprise a collection of various instances, or streams, of live content and/or recorded content. The collection of various instances, or streams, of live content and/or recorded content may be provided by one or more cameras, such as video cameras. For example, an individual stream of live or recorded content can comprise media data associated with a video feed provided by a video camera (e.g., audio and visual data that capture the appearance and speech of a user participating in the communication session). In some implementations, the video feeds may comprise such audio and visual data, one or more still images, and/or one or more avatars. The one or more still images may also comprise one or more avatars.

Another example of an individual stream of live or recorded content can comprise media data that includes an avatar of a user participating in the communication session along with audio data that captures the speech of the user. Yet another example of an individual stream of live or recorded content can comprise media data that includes a file displayed on a display screen along with audio data that captures the speech of a user. Accordingly, the various streams of live or recorded content within the communication data enable a remote meeting to be facilitated between a group of people and the sharing of content within the group of people. In some implementations, the various streams of live or recorded content within the communication data may originate from a plurality of co-located video cameras, positioned in a space, such as a room, to record or stream live a presentation that includes one or more individuals presenting and one or more individuals consuming presented content.

A participant or attendee can view content of the communication session 603 live as activity occurs, or alternatively, via a recording at a later time after the activity occurs. In the examples described herein, client computing devices 606(1) through 606(N) participating in the communication session 603 are configured to receive and render for display, on a user interface of a display screen, communication data. The communication data can comprise a collection of various instances, or streams, of live and/or recorded content. For example, an individual stream of content can comprise media data associated with a video feed (e.g., audio and visual data that capture the appearance and speech of a user participating in the communication session). Another example of an individual stream of content can comprise media data that includes an avatar of a user participating in the conference session along with audio data that captures the speech of the user. Yet another example of an individual stream of content can comprise media data that includes a content item displayed on a display screen and/or audio data that captures the speech of a user. Accordingly, the various streams of content within the communication data enable a meeting or a broadcast presentation to be facilitated amongst a group of people dispersed across remote locations.

A participant or attendee to a communication session is a person that is in range of a camera, or other image and/or audio capture device such that actions and/or sounds of the person which are produced while the person is viewing and/or listening to the content being shared via the communication session can be captured (e.g., recorded). For instance, a participant may be sitting in a crowd viewing the shared content live at a broadcast location where a stage presentation occurs. Or a participant may be sitting in an office conference room viewing the shared content of a communication session with other colleagues via a display screen. Even further, a participant may be sitting or standing in front of a personal device (e.g., tablet, smartphone, computer, etc.) viewing the shared content of a communication session alone in their office or at home.

The system 602 of FIG. 8 includes device(s) 610. The device(s) 610 and/or other components of the system 602 can include distributed computing resources that communicate with one another and/or with the client computing devices 606(1) through 606(N) via the one or more network(s) 608. In some examples, the system 602 may be an independent system that is tasked with managing aspects of one or more communication sessions such as communication session 603. As an example, the system 602 may be managed by entities such as SLACK, WEBEX, GOTOMEETING, GOOGLE HANGOUTS, etc.

Network(s) 608 may include, for example, public networks such as the Internet, private networks such as an institutional and/or personal intranet, or some combination of private and public networks. Network(s) 608 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 608 may utilize communications protocols, including packet-based and/or datagram-based protocols such as Internet protocol (“IP”), transmission control protocol (“TCP”), user datagram protocol (“UDP”), or other types of protocols. Moreover, network(s) 608 may also include a number of devices that facilitate network communications and/or form a hardware basis for the networks, such as switches, routers, gateways, access points, firewalls, base stations, repeaters, backbone devices, and the like.

In some examples, network(s) 608 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.11 standards (e.g., 802.11g, 802.11n, 802.11ac and so forth), and other standards.

In various examples, device(s) 610 may include one or more computing devices that operate in a cluster or other grouped configuration to share resources, balance load, increase performance, provide fail-over support or redundancy, or for other purposes. For instance, device(s) 610 may belong to a variety of classes of devices such as traditional server-type devices, desktop computer-type devices, and/or mobile-type devices. Thus, although illustrated as a single type of device or a server-type device, device(s) 610 may include a diverse variety of device types and are not limited to a particular type of device. Device(s) 610 may represent, but are not limited to, server computers, desktop computers, web-server computers, personal computers, mobile computers, laptop computers, tablet computers, or any other sort of computing device.

A client computing device (e.g., one of client computing device(s) 606(1) through 606(N)) (each of which are also referred to herein as a “data processing system”) may belong to a variety of classes of devices, which may be the same as, or different from, device(s) 610, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a telecommunication device, a computer navigation type client computing device such as a satellite-based navigation system including a global positioning system (“GPS”) device, a wearable device, a virtual reality (“VR”) device, an augmented reality (“AR”) device, an implanted computing device, an automotive computer, a network-enabled television, a thin client, a terminal, an Internet of Things (“IoT”) device, a work station, a media player, a personal video recorder (“PVR”), a set-top box, a camera, an integrated component (e.g., a peripheral device) for inclusion in a computing device, an appliance, or any other sort of computing device. Moreover, the client computing device may include a combination of the earlier listed examples of the client computing device such as, for example, desktop computer-type devices or a mobile-type device in combination with a wearable device, etc.

Client computing device(s) 606(1) through 606(N) of the various classes and device types can represent any type of computing device having one or more data processing unit(s) 692 operably connected to computer-readable media 694 such as via a bus 616, which in some instances can include one or more of a system bus, a data bus, an address bus, a PCI bus, a Mini-PCI bus, and any variety of local, peripheral, and/or independent buses.

Executable instructions stored on computer-readable media 694 may include, for example, an operating system 619, a client module 620, a profile module 622, and other modules, programs, or applications that are loadable and executable by data processing units(s) 692.

Client computing device(s) 606(1) through 606(N) may also include one or more interface(s) 624 to enable communications between client computing device(s) 606(1) through 606(N) and other networked devices, such as device(s) 610, over network(s) 608. Such network interface(s) 624 may include one or more network interface controllers (NICs) or other types of transceiver devices to send and receive communications and/or data over a network. Moreover, client computing device(s) 606(1) through 606(N) can include input/output (“I/O”) interfaces (devices) 626 that enable communications with input/output devices such as user input devices including peripheral input devices (e.g., a game controller, a keyboard, a mouse, a pen, a voice input device such as a microphone, a video camera for obtaining and providing video feeds and/or still images, a touch input device, a gestural input device, and the like) and/or output devices including peripheral output devices (e.g., a display, a printer, audio speakers, a haptic output device, and the like). FIG. 8 illustrates that client computing device 606(1) is in some way connected to a display device (e.g., a display screen 629(N)), which can display a UI according to the techniques described herein.

In the example environment 600 of FIG. 8, client computing devices 606(1) through 606(N) may use their respective client modules 620 to connect with one another and/or other external device(s) in order to participate in the communication session 603, or in order to contribute activity to a collaboration environment. For instance, a first user may utilize a client computing device 606(1) to communicate with a second user of another client computing device 606(2). When executing client modules 620, the users may share data, which may cause the client computing device 606(1) to connect to the system 602 and/or the other client computing devices 606(2) through 606(N) over the network(s) 608.

The client computing device(s) 606(1) through 606(N) may use their respective profile modules 622 to generate participant profiles (not shown in FIG. 8) and provide the participant profiles to other client computing devices and/or to the device(s) 610 of the system 602. A participant profile may include one or more of an identity of a user or a group of users (e.g., a name, a unique identifier (“ID”), etc.), user data such as personal data, machine data such as location (e.g., an IP address, a room in a building, etc.) and technical capabilities, etc. Participant profiles may be utilized to register participants for communication sessions.

As shown in FIG. 8, the device(s) 610 of the system 602 include a server module 630 and an output module 632. In this example, the server module 630 is configured to receive, from individual client computing devices such as client computing devices 606(1) through 606(N), media streams 634(1) through 634(N). As described above, media streams can comprise a video feed (e.g., audio and visual data associated with a user), audio data which is to be output with a presentation of an avatar of a user (e.g., an audio only experience in which video data of the user is not transmitted), text data (e.g., text messages), file data and/or screen sharing data (e.g., a document, a slide deck, an image, a video displayed on a display screen, etc.), and so forth. Thus, the server module 630 is configured to receive a collection of various media streams 634(1) through 634(N) during a live viewing of the communication session 603 (the collection being referred to herein as “media data 634”). In some scenarios, not all of the client computing devices that participate in the communication session 603 provide a media stream. For example, a client computing device may only be a consuming, or a “listening”, device such that it only receives content associated with the communication session 603 but does not provide any content to the communication session 603.

In various examples, the server module 630 can select aspects of the media streams 634 that are to be shared with individual ones of the participating client computing devices 606(1) through 606(N). Consequently, the server module 630 may be configured to generate session data 636 based on the streams 634 and/or pass the session data 636 to the output module 632. Then, the output module 632 may communicate communication data 639 to the client computing devices (e.g., client computing devices 606(1) through 606(3) participating in a live viewing of the communication session). The communication data 639 may include video, audio, and/or other content data, provided by the output module 632 based on content 650 associated with the output module 632 and based on received session data 636. The content 650 can include the streams 634 or other shared data, such as an image file, a spreadsheet file, a slide deck, a document, etc. The streams 634 can include a video component depicting images captured by an I/O device 626 on each client computer. The content 650 also include input data from each user, which can be used to control a direction and location of a representation. The content can also include instructions for sharing data and identifiers for recipients of the shared data. Thus, the content 650 is also referred to herein as input data 650 or an input 650.

As shown, the output module 632 transmits communication data 639(1) to client computing device 606(1), and transmits communication data 639(2) to client computing device 606(2), and transmits communication data 639(3) to client computing device 606(3), etc. The communication data 639 transmitted to the client computing devices can be the same or can be different (e.g., positioning of streams of content within a user interface may vary from one device to the next).

In various implementations, the device(s) 610 and/or the client module 620 can include GUI presentation module 640. The GUI presentation module 640 may be configured to analyze communication data 639 that is for delivery to one or more of the client computing devices 606. Specifically, the UI presentation module 640, at the device(s) 610 and/or the client computing device 606, may analyze communication data 639 to determine an appropriate manner for displaying video, image, and/or content on the display screen 629 of an associated client computing device 606. In some implementations, the GUI presentation module 640 may provide video, image, and/or content to a presentation GUI 646 rendered on the display screen 629 of the associated client computing device 606. The presentation GUI 646 may be caused to be rendered on the display screen 629 by the GUI presentation module 640. The presentation GUI 646 may include the video, image, and/or content analyzed by the GUI presentation module 640.

In some implementations, the presentation GUI 646 may include a plurality of sections or grids that may render or comprise video, image, and/or content for display on the display screen 629. For example, a first section of the presentation GUI 646 may include a video feed of a presenter or individual, a second section of the presentation GUI 646 may include a video feed of an individual consuming meeting information provided by the presenter or individual. The GUI presentation module 640 may populate the first and second sections of the presentation GUI 646 in a manner that properly imitates an environment experience that the presenter and the individual may be sharing.

In some implementations, the GUI presentation module 640 may enlarge or provide a zoomed view of the individual represented by the video feed in order to highlight a reaction, such as a facial feature, the individual had to the presenter. In some implementations, the presentation GUI 646 may include a video feed of a plurality of participants associated with a meeting, such as a general communication session. In other implementations, the presentation GUI 646 may be associated with a channel, such as a chat channel, enterprise Teams channel, or the like. Therefore, the presentation GUI 646 may be associated with an external communication session that is different from the general communication session.

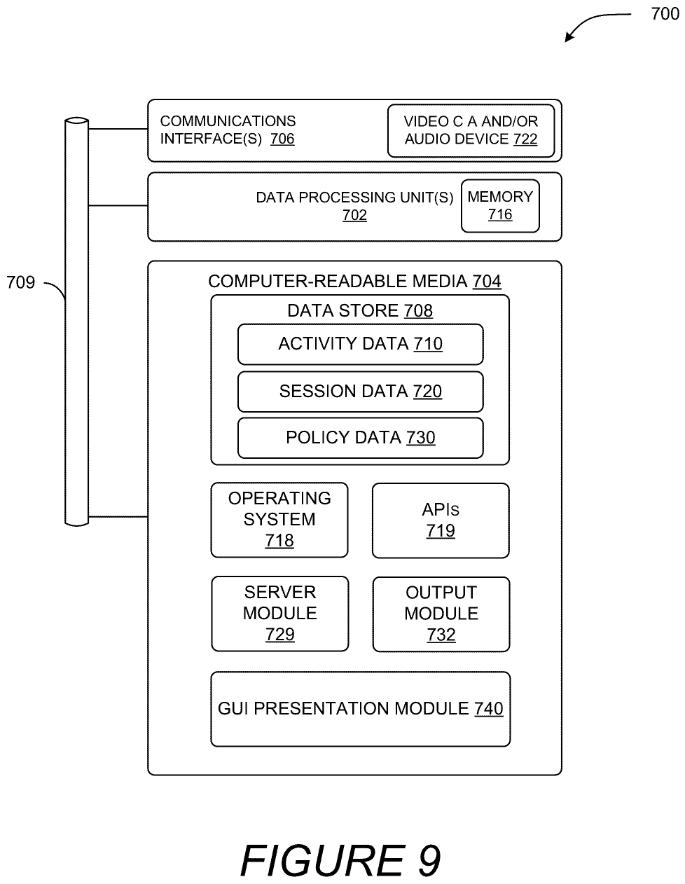

FIG. 9 illustrates a diagram that shows example components of an example device 700 (also referred to herein as a “computing device”) configured to generate data for some of the user interfaces disclosed herein. The device 700 may generate data that may include one or more sections that may render or comprise video, images, virtual objects, and/or content for display on the display screen 629. The device 700 may represent one of the device(s) described herein. Additionally, or alternatively, the device 700 may represent one of the client computing devices 606.

As illustrated, the device 700 includes one or more data processing unit(s) 702, computer-readable media 704, and communication interface(s) 706. The components of the device 700 are operatively connected, for example, via a bus 709, which may include one or more of a system bus, a data bus, an address bus, a PCI bus, a Mini-PCI bus, and any variety of local, peripheral, and/or independent buses.

As utilized herein, data processing unit(s), such as the data processing unit(s) 702 and/or data processing unit(s) 692, may represent, for example, a CPU-type data processing unit, a GPU-type data processing unit, a field-programmable gate array (“FPGA”), another class of DSP, or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized herein, computer-readable media, such as computer-readable media 704 and computer-readable media 694, may store instructions executable by the data processing unit(s). The computer-readable media may also store instructions executable by external data processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media, which might also be referred to herein as a computer-readable medium, may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device. The computer storage media can also be referred to herein as computer-readable storage media, non-transitory computer-readable storage media, non-transitory computer-readable medium, or computer storage medium.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 706 may represent, for example, network interface controllers (“NICs”) or other types of transceiver devices to send and receive communications over a network. Furthermore, the communication interface(s) 706 may include one or more video cameras and/or audio devices 722 to enable generation of video feeds and/or still images, and so forth.

In the illustrated example, computer-readable media 704 includes a data store 708. In some examples, the data store 708 includes data storage such as a database, data warehouse, or other type of structured or unstructured data storage. In some examples, the data store 708 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 708 may store data for the operations of processes, applications, components, and/or modules stored in computer-readable media 704 and/or executed by data processing unit(s) 702 and/or accelerator(s). For instance, in some examples, the data store 708 may store activity data 710, session data 720, and policy data 730. The session data 710 can include a total number of participants (e.g., users and/or client computing devices) in a communication session, activity that occurs in the communication session, a list of invitees to the communication session, and/or other data related to when and how the communication session is conducted or hosted.

The activity data 710 can define any type of activity or status related to the individual users 10A-10L. For instance, the contextual data can define a person's level in an organization, how each person's level relates to the level of others, a performance level of a person, or any other activity or status information that can be used to determine when an invitation can be sent. When a person joins a meeting, any information related to that person can be analyzed against the policy data and or the session data to determine if one or more criteria is met for delivering an invitation.

Some or all of the above-referenced data can be stored on separate memories 716 on board one or more data processing unit(s) 702 such as a memory on board a CPU-type processor, a GPU-type processor, an FPGA-type accelerator, a DSP-type accelerator, and/or another accelerator. In this example, the computer-readable media 704 also includes an operating system 718 and application programming interface(s) 719 (APIs) configured to expose the functionality and the data of the device 700 to other devices. Additionally, the computer-readable media 704 includes one or more modules such as the server module 729, the output module 732, and the GUI presentation module 740, although the number of illustrated modules is just an example, and the number may vary. That is, functionality described herein in association with the illustrated modules may be performed by a fewer number of modules or a larger number of modules on one device or spread across multiple devices.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

I/We claim:

1. A method for controlling delivery of a conditional notification for a communication session, the method for execution on a system, the method comprising:
monitoring activity data pertaining to activities associated with the communication session;
determining that the activity data associated with the communication session meeting one or more criteria with respect to a preset event;
in response to determining that the activity data meeting the one or more criteria with respect to the preset event, causing a display of a conditional notification to an absent user not yet joining the communication session on the computing device associated with the absent user, wherein the conditional notification is sent to the absent user subsequent to a delivery of an original notification to the communication session, wherein the conditional notification includes:
a first selectable option, when activated, for causing the computing device associated with the absent user to join the communication session, and
a second selectable option, when activated, for causing the computing device associated with the absent user to generate a response to decline joining the communication session and to cause a generation of a recording of the communication session; and
in response to receiving the response to decline joining the communication session and cause the generation of the recording, causing the generation of the recording of the communication session; and
communicating the recording of the communication session to the computing device associated with the absent user.

2. The method of claim 1, wherein the system monitors the activity data pertaining to a plurality of individuals of the communication session to determine that the activity data that defines activity of one or more attendees of the plurality of individuals meets one or more criteria with respect to the preset event or the communication session, wherein the user activity of one or more attendees meets one or more criteria with respect to the preset event when a number of the one or more attendees that have joined the preset event exceeds a threshold number, wherein the conditional notification is communicated to the computing device associated with the absent user for display in response to determining that the number of the one or more attendees that have joined the communication session exceeds the threshold number.

3. The method of claim 1, wherein the user activity of the one or more attendees meets one or more criteria with respect to the preset event when the one or more attendees have identities listed in a participant list, wherein the identities listed in the participant list are controlled by users with administrative permissions or has a moderator role in the communication session, wherein the conditional notification is communicated to the computing device of the invitee for display in response to determining that the one or more attendees have identities listed in the participant list.

4. The method of claim 1, wherein the user activity of the one or more attendees meets one or more criteria with respect to the preset event when it is determined that a reply to an initial notification addressed to the absent user indicated a tentative attendance or the reply to the initial notification was not received by the system, wherein the conditional notification is communicated to the computing device associated with the absent user for display in response to determining that the reply to the initial notification addressed to the absent user indicated the tentative attendance or the reply to the initial notification was not received by the system, wherein the conditional notification is restricted from communication to the computing device associated with the absent user if the reply to the initial notification indicated a rejection to join the communication session.

5. The method of claim 1, wherein the user activity of the one or more attendees meets one or more criteria with respect to the preset event when the absent user has an associated identity on a status list, wherein the conditional notification is communicated to the computing device associated with the absent user for display in response to determining that the absent user has the associated identity on the status list and that the identity is marked as out of office.

6. The method of claim 1, wherein the user activity of the one or more attendees meets one or more criteria with respect to the preset event when the one or more attendees have identities associated with a predetermined title, wherein the conditional notification is communicated to the computing device associated with the absent user for display in response to determining that the one or more attendees have identities associated with the predetermined title.

7. The method of claim 1, wherein the user activity of the one or more attendees meets one or more criteria with respect to the preset event when the one or more attendees have identities associated with a predetermined meeting role, wherein the conditional notification is communicated to the computing device associated with the absent user for display in response to determining that the one or more attendees have identities associated with the meeting role.

8. A system for controlling delivery of a conditional notification for a communication session, the system comprising:
one or more processing units; and
a computer-readable storage medium having encoded thereon computer-executable instructions to cause the one or more processing units to:
monitor activity data pertaining to activities associated with the communication session;
determine that the activity data associated with the communication session meeting one or more criteria with respect to a preset event;
in response to determining that the activity data meeting the one or more criteria with respect to the preset event, causing a display of a conditional notification to an absent user not yet joining the communication session on the computing device associated with the absent user, wherein the conditional notification is sent to the absent user subsequent to a delivery of an original notification to the communication session, wherein the conditional notification includes:
a first selectable option, when activated, for causing the computing device associated with the absent user to join the communication session, and
a second selectable option, when activated, for causing the computing device associated with the absent user to generate a response to decline joining the communication session and to cause a generation of a recording of the communication session; and
in response to receiving the response to decline joining the communication session and cause the generation of the recording, cause the generation of the recording of the communication session; and
communicate the recording of the communication session to the computing device associated with the absent user.

9. The system of claim 8, wherein the user activity of one or more attendees meets one or more criteria with respect to the preset event when a number of the one or more attendees that have joined the communication session exceeds a threshold number, wherein the conditional notification is communicated to the computing device associated with the absent user for display in response to determining that the number of the one or more attendees that have joined the communication session exceeds the threshold number.

10. The system of claim 8, wherein the user activity of the one or more attendees meets one or more criteria with respect to the preset event when the one or more attendees have identities listed in a participant list, wherein the identities listed in the participant list are controlled by users with administrative permissions or has a moderator role in the communication session, wherein the conditional notification is communicated to the computing device of the invitee for display in response to determining that the one or more attendees have identities listed in the participant list.

11. The system of claim 8, wherein the user activity of the one or more attendees meets one or more criteria with respect to the preset event when it is determined that a reply to an initial notification addressed to the absent user indicated a tentative attendance or the reply to the initial notification was not received by the system, wherein the conditional notification is communicated to the computing device associated with the absent user for display in response to determining that the reply to the initial notification addressed to the absent user indicated the tentative attendance or the reply to the initial notification was not received by the system, wherein the conditional notification is restricted from communication to the computing device associated with the absent user if the reply to the initial notification indicated a rejection to the communication session.

12. The system of claim 8, wherein the user activity of the one or more attendees meets one or more criteria with respect to the preset event when the absent user has an associated identity on a status list, wherein the conditional notification is communicated to the computing device associated with the absent user for display in response to determining that the absent user has the associated identity on the status list and that the identity is marked as out of office.

13. The system of claim 8, wherein the user activity of the one or more attendees meets one or more criteria with respect to the preset event when the one or more attendees have identities associated with a predetermined title, wherein the conditional notification is communicated to the computing device associated with the absent user for display in response to determining that the one or more attendees have identities associated with the predetermined title.

14. The system of claim 8, wherein the user activity of the one or more attendees meets one or more criteria with respect to the preset event when the one or more attendees have identities associated with a predetermined meeting role, wherein the conditional notification is communicated to the computing device associated with the absent user for display in response to determining that the one or more attendees have identities associated with the meeting role.

15. A computer-readable storage medium having encoded thereon computer-executable instructions to cause one or more processing units of a system to control delivery of a conditional notification for a communication session, wherein the instructions to cause one or more processing units to:
monitor activity data pertaining to activities associated with the communication session;
determine that the activity data associated with the communication session meeting one or more criteria with respect to a preset event;
in response to determining that the activity data meeting the one or more criteria with respect to the preset event, causing a display of a conditional notification to an absent user not yet joining the communication session on the computing device associated with the absent user, wherein the conditional notification is sent to the absent user subsequent to a delivery of an original notification to the communication session, wherein the conditional notification includes:
a first selectable option, when activated, for causing the computing device associated with the absent user to join the communication session, and
a second selectable option, when activated, for causing the computing device associated with the absent user to generate a response to decline joining the communication session and to cause a generation of a recording of the communication session; and
in response to receiving the response to decline joining the communication session and cause the generation of the recording, cause the generation of the recording of the communication session; and
communicate the recording of the communication session to the computing device associated with the absent user.

16. The computer-readable storage medium of claim 15, wherein the user activity of one or more attendees meets one or more criteria with respect to the preset event when a number of the one or more attendees that have joined the communication session exceeds a threshold number, wherein the conditional notification is communicated to the computing device associated with the absent user for display in response to determining that the number of the one or more attendees that have joined the communication session exceeds the threshold number.

17. The computer-readable storage medium of claim 15, wherein the user activity of the one or more attendees meets one or more criteria with respect to the preset event when the one or more attendees have identities listed in a participant list, wherein the identities listed in the participant list are controlled by users with administrative permissions or has a moderator role in the communication session, wherein the conditional notification is communicated to the computing device of the invitee for display in response to determining that the one or more attendees have identities listed in the participant list.

18. The computer-readable storage medium of claim 15, wherein the user activity of the one or more attendees meets one or more criteria with respect to the preset event when it is determined that a reply to an initial notification addressed to the absent user indicated a tentative attendance or the reply to the initial notification was not received by the system, wherein the conditional notification is communicated to the computing device associated with the absent user for display in response to determining that the reply to the initial notification addressed to the absent user indicated the tentative attendance or the reply to the initial notification was not received by the system, wherein the conditional notification is restricted from communication to the computing device associated with the absent user if the reply to the initial notification indicated a rejection to the communication session.

19. The computer-readable storage medium of claim 15, wherein the user activity of the one or more attendees meets one or more criteria with respect to the preset event when the absent user has an associated identity on a status list, wherein the conditional notification is communicated to the computing device associated with the absent user for display in response to determining that the absent user has the associated identity on the status list and that the identity is marked as out of office.

20. The computer-readable storage medium of claim 15, wherein the user activity of the one or more attendees meets one or more criteria with respect to the preset event when the one or more attendees have identities associated with a predetermined title, wherein the conditional notification is communicated to the computing device associated with the absent user for display in response to determining that the one or more attendees have identities associated with the predetermined title.
